(19) United States
(12) Patent Application Publication
(10) Pub. No.: US 2013/0063721 A1
(43) Pub. Date: Mar. 14, 2013

(54) PATTERN INSPECTION APPARATUS AND METHOD

(71) Applicants: Takayoshi FUJII, Yokohama-shi (JP); Yusaku KONNO, Yokohama-shi (JP); Makoto KANEKO, Yokkaichi-shi (JP); Yuichiro YAMAZAKI, Yokkaichi-shi (JP); Mitsutoshi WATABIKI, Yokkaichi-shi (JP); Kiminori YOSHINO, Yokkaichi-shi (JP); Yusuke IIDA, Yokkaichi-shi (JP)

(72) Inventors: Takayoshi FUJII, Yokohama-shi (JP); Yusaku KONNO, Yokohama-shi (JP); Makoto KANEKO, Yokkaichi-shi (JP); Yuichiro YAMAZAKI, Yokkaichi-shi (JP); Mitsutoshi WATABIKI, Yokkaichi-shi (JP); Kiminori YOSHINO, Yokkaichi-shi (JP); Yusuke IIDA, Yokkaichi-shi (JP)

(73) Assignee: KABUSHIKI KAISHA TOSHIBA, Tokyo (JP)

(21) Appl. No.: 13/414,945

(22) Filed: Mar. 8, 2012

(30) Foreign Application Priority Data
Sep. 12, 2011 (JP) 2011-198656

(51) Int. Cl. G01J 3/42

(52) U.S. Cl. 356/306

(57) ABSTRACT

In one embodiment, a pattern inspection apparatus includes a light source configured to generate light, and a condenser configured to shape the light into a line beam to illuminate a wafer with the line beam. The apparatus further includes a spectrometer configured to disperse the line beam reflected from the wafer. The apparatus further includes a two-dimensional detector configured to detect the line beam dispersed by the spectrometer, and output a signal including spectrum information of the line beam. The apparatus further includes a comparison unit configured to compare the spectrum information obtained from corresponding places of a repetitive pattern on the wafer with each other, and a determination unit configured to determine whether the wafer includes a defect, based on a comparison result of the spectrum information.

### CROSS REFERENCE TO RELATED APPLICATION

This application is based upon and claims the benefit of priority from the prior Japanese Patent Application No. 2011-198656, filed on Sep. 12, 2011, the entire contents of which are incorporated herein by reference.

1. Field

Embodiments described herein relate to a pattern inspection apparatus and method.

2. Background

A conventional pattern inspection apparatus illuminates a wafer with light from a lamp light source, forms an image on a two-dimensional detector with the reflected light from the wafer so as to obtain the image, and compares pixel values obtained from corresponding places of a repetitive pattern on the wafer with each other, thereby determining whether the wafer includes a defect.

The wavelength of the light for the wafer illumination is set by selecting a wavelength range suitable for the structure and the defect of the wafer from a wide wavelength range of the lump light source by using a bandpass filter. In this case, the suitable wavelength changes due to variations of an underlying structure in the wafer plane, between wafers, and between lots, and variations of the heights of the defects. This often results in missing of the defects.

Furthermore, although the conventional pattern inspection apparatus illuminates the wafer with the light which illuminates a definite area, the wafer may be illuminated with a spot beam instead of such light. However, it is necessary in this case to scan the wafer with the spot beam. This results in a problem that the throughput is slow as compared with the case where the wafer is illuminated with the light illuminating a definite area.

### BRIEF DESCRIPTION OF THE DRAWINGS

FIG. 1 is a schematic diagram showing a configuration of an optical system in a pattern inspection apparatus of a first embodiment;

FIGS. 2A to 3C are wafer sectional views and graphs for explaining a first example of a pattern inspection method of the first embodiment;

FIGS. 4A to 5C are wafer sectional views and graphs for explaining the first example of the pattern inspection method of the first embodiment;

FIGS. 6A to 7E are wafer sectional views and graphs for explaining a second example of the pattern inspection method of the first embodiment;

FIG. 8 is a schematic diagram showing a configuration of an optical system in a pattern inspection apparatus of a second embodiment; and

FIG. 9 is a schematic diagram showing a configuration of an optical system in a pattern inspection apparatus of a third embodiment; and

FIGS. 10A and 10B are schematic diagrams showing configurations of spatial filters of the third embodiment.

### DETAILED DESCRIPTION

Embodiments will now be explained with reference to the accompanying drawings.

An embodiment described herein is a pattern inspection apparatus including a light source configured to generate light, and a condenser configured to shape the light into a line beam to illuminate a wafer with the line beam. The apparatus further includes a spectrometer configured to disperse the line beam reflected from the wafer. The apparatus further includes a two-dimensional detector configured to detect the line beam dispersed by the spectrometer, and output a signal including spectrum information of the line beam. The apparatus further includes a comparison unit configured to compare the spectrum information obtained from corresponding places of a repetitive pattern on the wafer with each other, and a determination unit configured to determine whether the wafer includes a defect, based on a comparison result of the spectrum information.

### First Embodiment

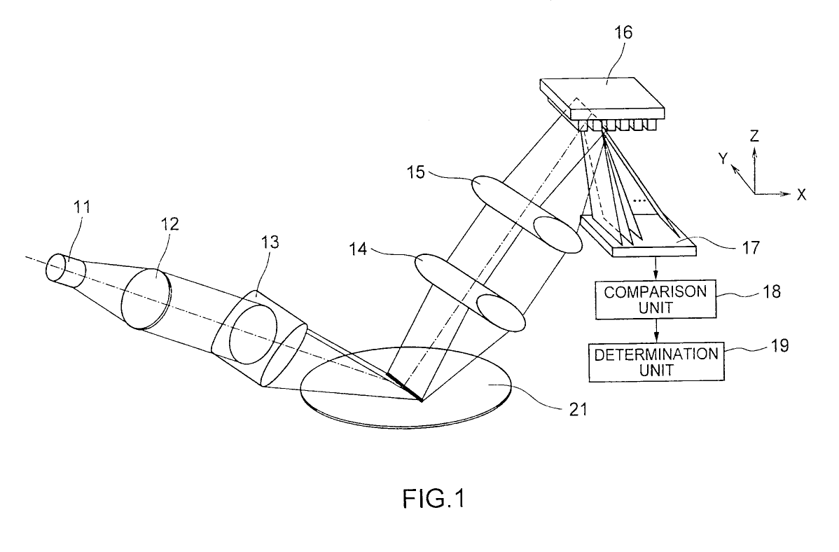

FIG. 1 is a schematic diagram showing a configuration of an optical system in a pattern inspection apparatus of a first embodiment.

The pattern inspection apparatus of FIG. 1 includes a light source 11, a convex lens 12, a first cylindrical lens 13 as a condenser lens, a second cylindrical lens 14 as an object lens, a third cylindrical lens 15 as an imaging lens, a grating 16, a charge coupled device (CCD) sensor 17, a comparison unit 18, and a determination unit 19.

The light source 11 is a white light source having a wide wavelength band. In the present embodiment, a lamp light source is used as the light source 11. Examples of the lamp light source include an Hg (mercury) lamp, a Xe (xenon) lamp, a halogen lamp and the like.

White light generated from the light source 11 is converted into parallel light by the convex lens 12. The white light is further shaped into a line beam by the first cylindrical lens 13 to illuminate a wafer 21 with the line beam. The first cylindrical lens 13 is an example of a condenser.

The line beam reflected from the wafer 21 passes through the second cylindrical lens 14 which converts the light diverged by the scattering into parallel light, and then passes through the third cylindrical lens 15 to form an image on the grating 16. The line beam is then dispersed by the grating 16. The grating 16 is an example of a spectrometer.

The line beam incident on the grating 16 is white light, and therefore it contains light components of various wavelengths. The light components of the white light are changed in traveling angle according to the wavelengths by the grating 16 to illuminate the CCD sensor 17 with those light components. Therefore, the light receiving plane of the CCD sensor 17 detects information corresponding to a difference in wavelengths along a first direction, and detects information corresponding to a difference in positions in the line beam along a second direction perpendicular to the first direction. In FIG. 1, the first direction is indicated as an X direction, and the second direction is indicated as a Y direction.

In this way, the CCD sensor 17 detects the line beam dispersed by the grating 16 as a whole. The CCD sensor 17 then outputs a signal including detected spectrum information of the line beam. The output signal is supplied to the comparison unit 18. The CCD sensor 17 is an example of a two-dimensional detector.

The pattern inspection apparatus of FIG. 1 conducts a process for obtaining such spectrum information on a repetitive pattern on the wafer 21. Then, the spectrum information obtained from corresponding places of the repetitive pattern on the wafer 21 is supplied to the comparison unit 18.

The comparison unit 18 compares the spectrum information obtained from the corresponding places of the repetitive pattern on the wafer 21 with each other. Specifically, the repetitive pattern includes plural patterns having the same shape, and therefore the comparison unit 18 compares spectra obtained from the corresponding places of those patterns with each other. For example, the comparison process by the comparison unit 18 is conducted between adjacent IC chips fabricated on the wafer 21, or in a repetitive circuit pattern in one IC chip.

The determination unit 19 then determines whether the wafer 21 includes a defect, based on a comparison result of the spectrum information. In this way, in the present embodiment, it is possible to determine whether the wafer 21 includes the defect by comparing the spectrum information obtained from the corresponding places of the repetitive pattern on the wafer 21 with each other.

As described above, the defect detection in the present embodiment is conducted by using the spectrum information of the reflected light from the wafer 21. Therefore, as the light for the wafer illumination, the white light is used instead of the light whose wavelength is set in a wavelength area suitable for the structure and the defect of the wafer 21. According to the present embodiment, therefore, inspection can be conducted by using plural wavelengths at one time. Therefore, even if the structure and the defect of the wafer 21 vary to change a suitable wavelength, the defect can be detected with high precision.

Examples of variations of the structure of the wafer 21 include variations of a thickness of a layer on the wafer 21, variations of a line width or height of a circuit pattern, and variations of a substance of a layer on the wafer 21 which causes changes of a refractive index and an absorption index. Examples of variations of the defect of the wafer 21 include variations of a defect height and size, and a difference of materials of defects such as dielectrics or metals.

Furthermore, in the present embodiment, the light for the wafer illumination is not a spot beam but a line beam. Therefore, as compared with the case where the wafer 21 is scanned with the spot beam, the spectrum information in the wafer plane can be obtained fast by scanning the wafer 21 with the line beam. Therefore, the present embodiment can conduct a pattern inspection which is fast in throughput.

The light for the wafer illumination may be light other than the white light as long as the light has spread in wavelength range. As a result, it becomes possible to detect the defect with high precision even if the suitable wavelength changes due to variations of the structure and the defect of the wafer 21, similarly to the case where the white light is used.

(1) First Example of Pattern Inspection Method

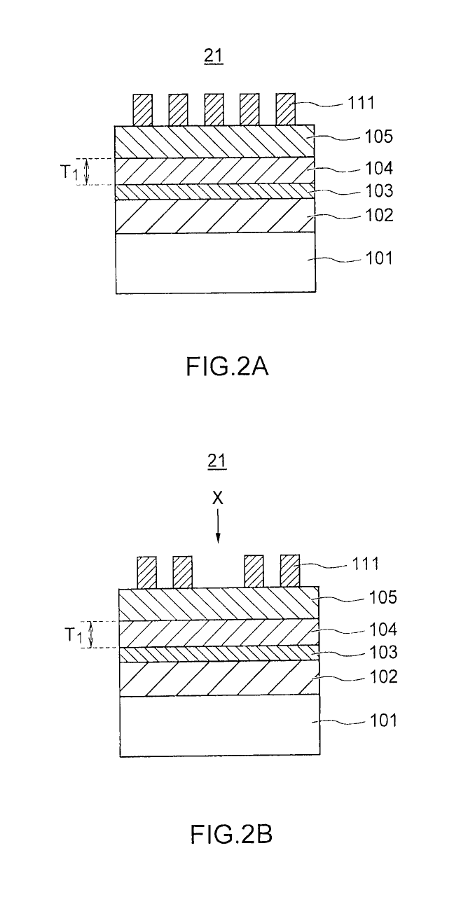

A first example of a pattern inspection method of the first embodiment will now be described with reference to FIGS. 2A to 5C.

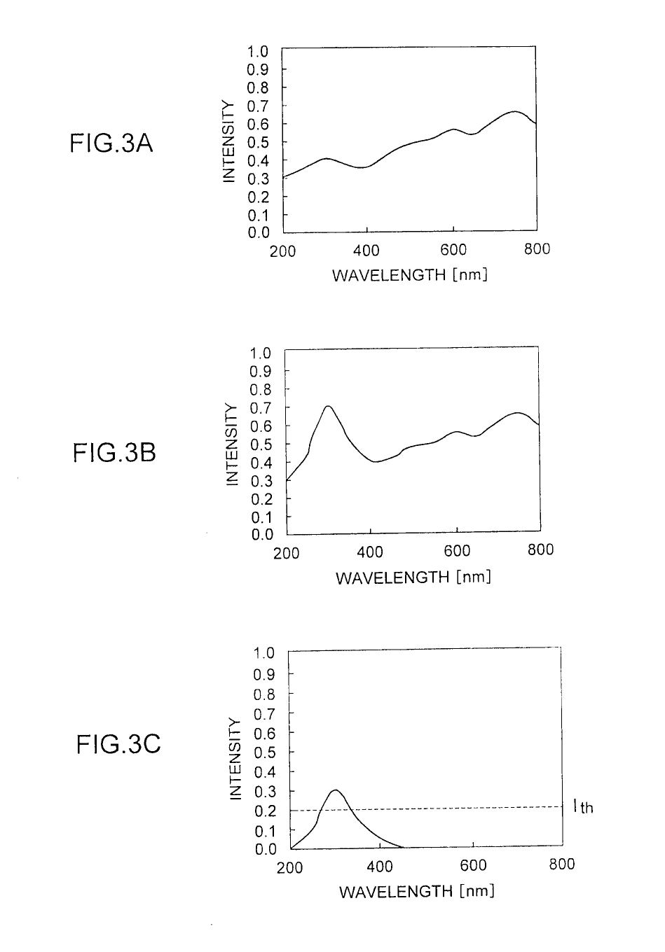

FIGS. 2A to 3C are wafer sectional views and graphs for explaining the first example of the pattern inspection method of the first embodiment.

FIG. 2A shows an example of a section of the wafer 21 of FIG. 1. In FIG. 2A, the wafer 21 includes a semiconductor substrate 101, stack layers 102 to 105 successively formed on the semiconductor substrate 101, and a pattern layer 111 formed on the stack layer 105. An example of the pattern layer 111 includes an interconnect layer including interconnect patterns.

FIG. 2B shows an example of a section of the wafer 21 of FIG. 1, similarly to FIG. 2A. Whereas FIG. 2A shows the section of a good product, FIG. 2B shows the section of a failure product having a defect X.

Hereafter, an inspection position in FIG. 2A is referred to as first inspection position, and an inspection position in FIG. 2B is referred to as second inspection position.

An example of a comparison method conducted by the comparison unit 18 includes a method of calculating a difference of spectra obtained from the corresponding places of the repetitive pattern on the wafer 21. In this comparison process, the difference is calculated, for example, between a first pattern on a first IC chip, and a second pattern having the same shape as that of the first pattern and located in the corresponding place on a second IC chip. In this case, each of the first and second patterns need not be the repetitive pattern. However, the repetitive pattern is formed by repeating plural patterns having the same shape as that of the first and second patterns among IC chips. Furthermore, in the comparison process, the difference is calculated, for example, between a first pattern which forms a repetitive pattern on an IC chip, and a second pattern having the same shape as the first pattern in the same repetitive pattern on the same IC chip.

FIGS. 3A and 3B show spectra obtained from the first and second inspection positions which are the corresponding places of the repetitive pattern on the wafer 21, respectively. FIG. 3C shows a difference between those spectra. Therefore, FIG. 3C shows a comparison result in the case where the first and second inspection positions are chosen as comparison objects. The abscissa axis in FIGS. 3A to 3C indicates the wavelength of the line beam, and the ordinate axis in FIGS. 3A to 3C indicates the intensity of the line beam.

If the first and second inspection positions include no defect, the difference intensity in FIG. 3C ought to be small in value at any wavelength. In this example, however, the second inspection position includes a defect. Therefore, in the spectra in the second inspection position, the intensity changes at a certain wavelength as shown in FIG. 3B. As a result, the difference intensity shown in FIG. 3C becomes a large value at this wavelength.

Therefore, the determination unit 19 determines whether the wafer 21 includes a defect based on the difference intensity shown in FIG. 3C. Specifically, the determination unit 19 determines that the wafer 21 includes a defect if the difference intensity is greater than a threshold at a wavelength. On the other hand, if the difference intensity is smaller than the threshold at any wavelength, the determination unit 19 determines that the wafer 21 includes no defect. In FIG. 3C, an example of the threshold is represented by Ith.

When comparing intensities in two inspection positions with each other, the comparison unit 18 may set one inspection position to be an inspection position where the determination has been already completed, and set the other inspection position to be an inspection position where the determination has not been conducted yet. In this case, the determination unit 19 determines whether the second inspection position on the wafer 21 includes a defect.

Furthermore, when comparing intensities in two inspection positions with each other, the comparison unit 18 may set both of the inspection positions to be inspection positions where the determination has not been conducted yet. In this case, the determination unit 19 outputs a determination result, for example, “either of the inspection positions includes a defect” or “both of the inspection positions include no defect.”

If the structure and the defect of the wafer 21 do not vary, the intensity change shown in FIG. 3B appears at a specific fixed wavelength. If the structure or the defect of the wafer 21 varies, however, the wavelength suitable for the structure or the defect of the wafer 21 changes, so that the wavelength at which the intensity change changes. Therefore, if the structure or the defect of the wafer 21 varies, the conventional pattern inspection apparatus often misses the defect. On the other hand, according to the present embodiment, such a defect can also be detected with high precision as described below.

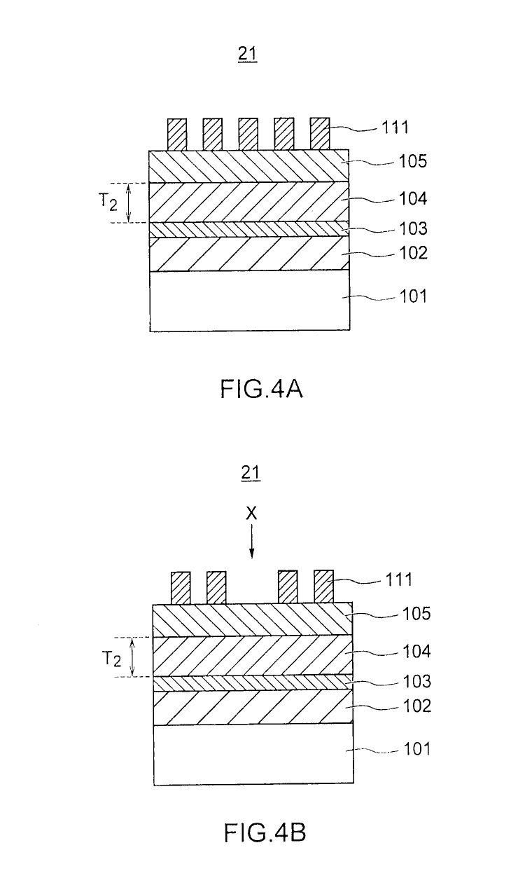

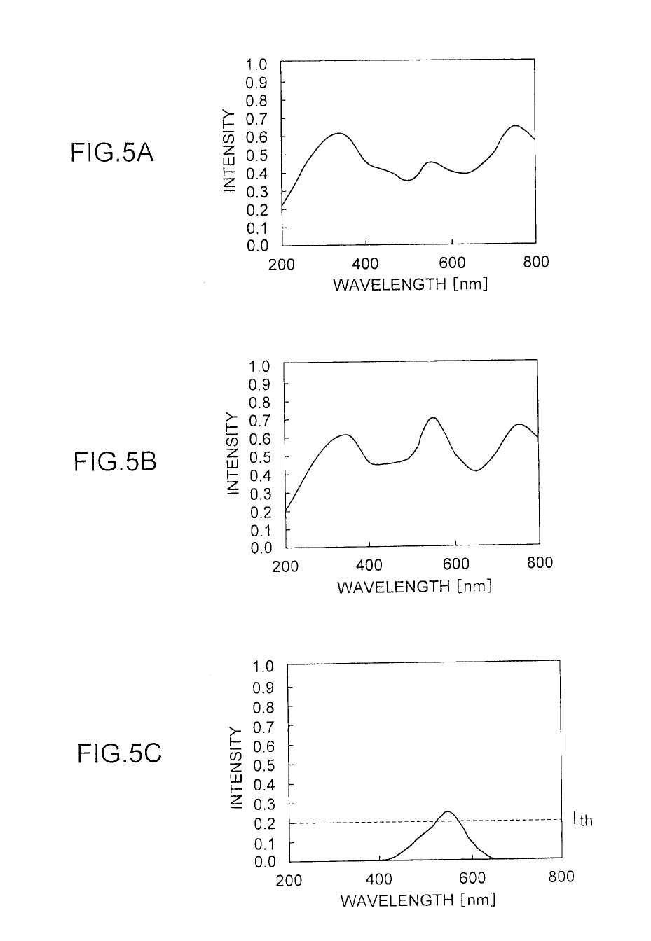

FIGS. 4A to 5C are wafer sectional views and graphs for explaining the first example of the pattern inspection method of the first embodiment, similarly to FIGS. 2A to 3C.

FIGS. 4A and 4B show sections of a good product and a failure product, similarly to FIGS. 2A and 2B. However, the stack layers 104 shown in FIGS. 2A and 2B have a thickness T₁, whereas the stack layers 104 shown in FIGS. 4A and 4B have a thickness T₂ which is greater than T₁. In other words, the wafers 21 in FIGS. 4A and 4B have structures which are different from those of the wafers 21 in FIGS. 2A and 2B.

Hereafter, the inspection position in FIG. 4A is referred to as first inspection position, and the inspection position in FIG. 4B is referred to as second inspection position.

FIGS. 5A and 5B show spectra obtained from the first and second inspection positions which are the corresponding places of the repetitive pattern on the wafer 21, respectively, similarly to FIGS. 3A and 3B. FIG. 5C shows a difference between those spectra, similarly to FIG. 3C.

In this example, the second inspection position includes a defect. Therefore, in spectra in the second inspection position, the intensity changes at a certain wavelength as shown in FIG. 5B. However, this wavelength is different from the wavelength at which the intensity changes in FIG. 3B. As a result, the difference intensity shown in FIG. 5C becomes a great value at a wavelength which is different from that of FIG. 3C.

If there is such a change in the wafer structure, the conventional pattern inspection apparatus cannot detect a defect with high precision. In the present embodiment, however, it is determined that the wafer 21 includes a defect if the difference intensity is greater than a threshold at a wavelength. Therefore, even if there is a such a change in the wafer structure, the defect can be detected with high precision in the present embodiment.

(2) Second Example of Pattern Inspection Method

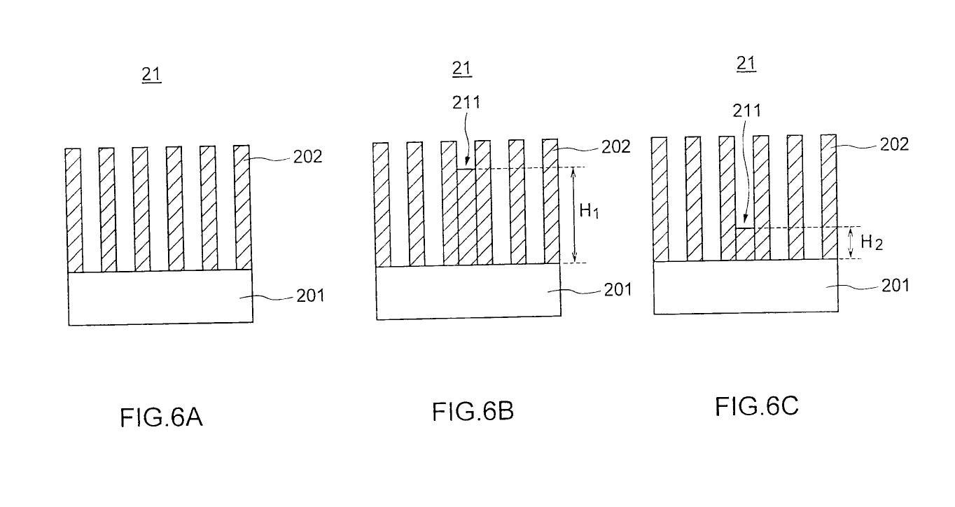

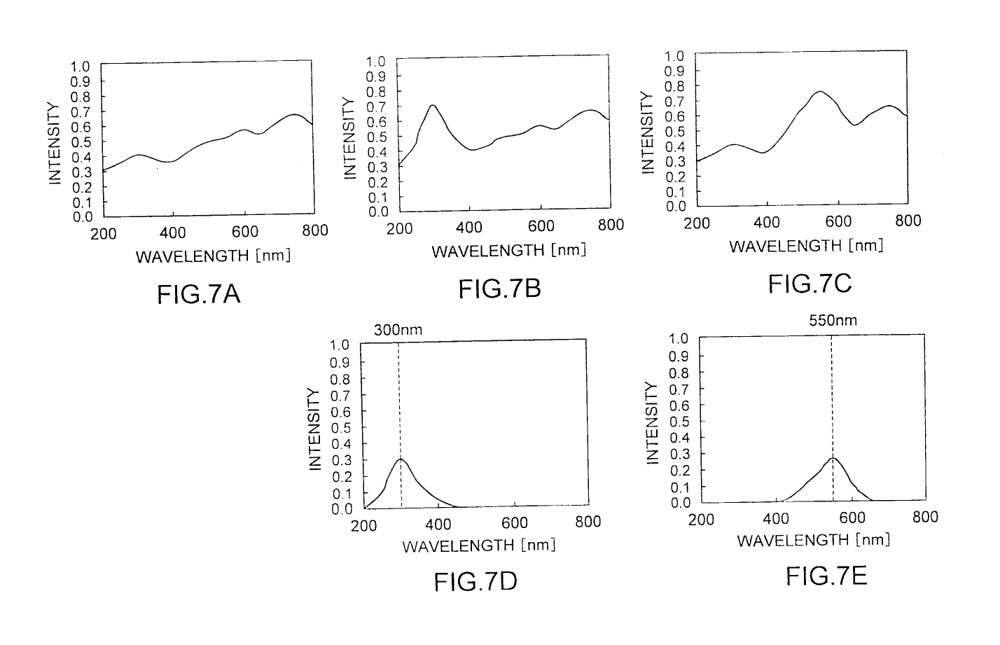

A second example of the pattern inspection method of the first embodiment will now be described with reference to FIGS. 6A to 7E.

FIGS. 6A to 7E are wafer sectional views and graphs for explaining the second example of the pattern inspection method of the second embodiment.

FIG. 6A shows an example of a section of the wafer 21 of FIG. 1. In FIG. 6A, the wafer 21 includes a semiconductor substrate 201, and a pattern layer 202 formed on the semiconductor substrate 201. An example of the pattern layer 202 includes an interconnect layer including interconnect patterns.

FIGS. 6B and 6C show an example of sections of the wafer 21 shown in FIG. 1, similarly to FIG. 6A. Whereas FIG. 6A shows the section of a good product, each of FIGS. 6B and 6C shows the section of a failure product having a defect 211. Whereas the defect 211 in FIG. 6B has a height H₁, the defect 211 in FIG. 6C has a height H₂ which is smaller than H₁. In other words, there is a variation in defect height between FIGS. 6B and 6C.

Hereafter, inspection positions in FIGS. 6A to 6C are referred to as first to third inspection positions, respectively.

The comparison unit 18 calculates a difference between spectra obtained from the corresponding places of the repetitive pattern on the wafer 21, similarly to the case of the first example. FIGS. 7A to 7C show spectra obtained from the first to third inspection positions, respectively. FIG. 7D shows a difference between spectra obtained from the first and second inspection positions, and FIG. 7E shows a difference between spectra obtained from the first and third inspection positions. The determination unit 19 determines whether the wafer 21 includes a defect based on those differences, similarly to the case of the first example.

Intensity changes in FIG. 7B and intensity changes in FIG. 7C appear at different wavelengths reflecting variations of the defect heights. As a result, the difference intensities shown in FIGS. 7D and 7E become great values at different wavelengths.

If there is such a change in the defect structure, the conventional pattern inspection apparatus cannot detect a defect with high precision. In the present embodiment, however, it is determined that the wafer 21 includes a defect if the difference intensity is greater than the threshold at a wavelength. Therefore, even if there is such a change in the defect structure, the defect can be detected with high precision in the present embodiment.

The intensity in FIG. 7B changes at a wavelength of 300 nm, and the intensity in FIG. 7C changes at a wavelength of 550 nm. According to the finding of the present inventors, the wavelength at which the intensity changes depends upon the height of the defect. Therefore, the pattern inspection apparatus of the present embodiment may estimate the defect height based on the wavelength at which the intensity changes. Such an estimation process can be realized, for example, by examining a correspondence between the defect height and the wavelength at which the intensity changes, and previously storing a table of the correspondence in the pattern inspection apparatus.

(3) Effects of First Embodiment

Finally, effects of the first embodiment will be described.

As described above, in the present embodiment, the defect detection is conducted by using the spectrum information of the reflected light from the wafer 21. According to the present embodiment, therefore, it is possible to detect the defect with high precision even if the structure and the defect of the wafer 21 vary and consequently the suitable wavelength changes.

Furthermore, in the present embodiment, the light for the wafer illumination is not a spot beam but a line beam. According to the present embodiment, therefore, it is possible to conduct the pattern inspection with a faster throughput as compared with the case where the spot beam is used.

### Second Embodiment

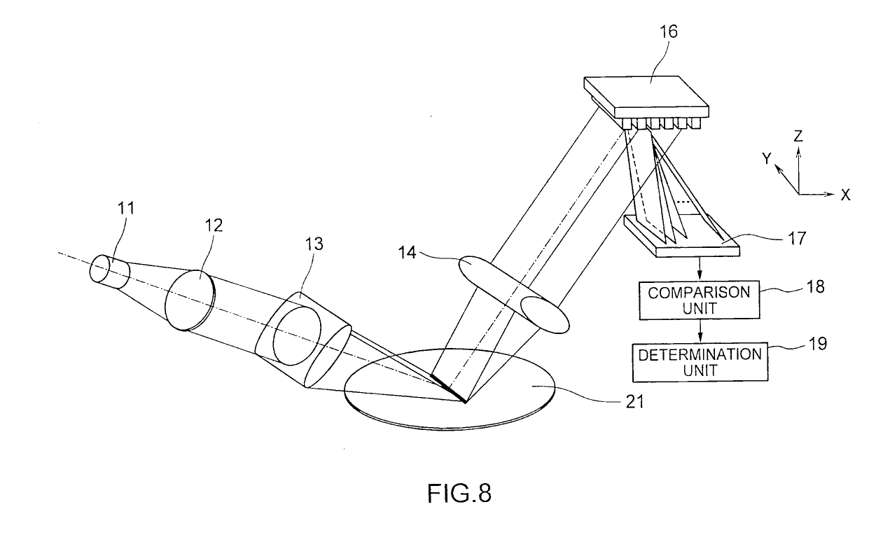

FIG. 8 is a schematic diagram showing a configuration of an optical system in a pattern inspection apparatus of a second embodiment.

The optical system in the pattern inspection apparatus of FIG. 1 includes the third cylindrical lens (imaging lens) 15, because its numerical aperture NA is comparatively large. On the other hand, the third cylindrical lens 15 is not provided in the optical system in the pattern inspection apparatus of FIG. 8, because its numerical aperture NA is comparatively small. The configuration shown in FIG. 8 has an advantage that the manufacturing cost can be reduced because the third cylindrical lens 15 is not needed.

According to the second embodiment, it is possible to detect the defect with high precision even if the structure and the defect of the wafer 21 vary and consequently the suitable wavelength changes, similarly to the first embodiment, and it is possible to conduct the pattern inspection with a fast throughput.

In the first and second embodiments, a spectrum camera in which the grating 16 and the CCD sensor 17 are united in a body may be adopted as the grating 16 and the CCD sensor 17.

### Third Embodiment

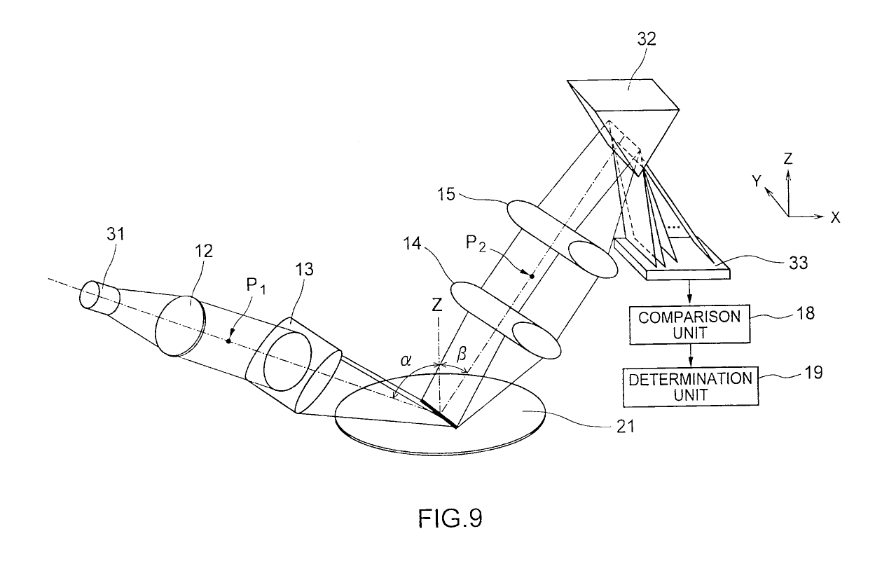

FIG. 9 is a schematic diagram showing a configuration of an optical system in a pattern inspection apparatus of a third embodiment.

The pattern inspection apparatus shown in FIG. 9 includes a supercontinuum light source 31, a prism 32, and a CMOS sensor 33 instead of the lamp light source 11, the grating 16, and the CCD sensor 17, respectively.

The supercontinuum light source 31 is a white light source which generates wideband laser light called supercontinuum light as the white light. The supercontinuum light source 31 has a merit that the brightness can be made larger than that of the lamp light source 11, so that the signal-to-noise ratio can be improved. In the present embodiment, the supercontinuum light source 31 may be replaced with another white light source such as a superluminescent diode light source.

The prism 32 is a spectrometer which disperses the line beam reflected from the wafer 21, similarly to the grating 16. The CMOS sensor 33 is a two-dimensional detector which detects the dispersed line beam, similarly to the CCD sensor 17.

The first and third cylindrical lenses 13 and 15 may be replaced by a condenser and an imager other than cylindrical lenses, respectively.

In the present embodiment, a polarizer or an analyzer may be disposed on an optical path between the light source 31 and a setting position of the wafer 21, or an optical path between the setting position of the wafer 21 and the prism 32. As a result, for example, it is possible to select polarized light (such as p-polarized light, s-polarized light, right-handed elliptically polarized light, or left-handed elliptically polarized light) suitable for the detection of each defect, thereby improving the defect detection sensitivity.

For example, if a line cut defect (open-circuit defect) having a broken interconnect is inspected when inspecting an interconnect pattern, it is desirable to use polarized light which vibrates in parallel to the interconnect direction. On the other hand, if a bridge defect (short-circuit defect) having a short-circuit between interconnects is inspected, it is desirable to use polarized light which vibrates perpendicularly to the interconnect direction. When inspecting an interconnect pattern, therefore, polarized light suitable for the type of the defect may be selected.

If the polarizer or the analyzer is disposed, an intensity ratio or a phase difference between the p-polarized light and the s-polarized light obtained from the line beam may be detected in the CMOS sensor 33, instead of the intensity of the line beam.

A symbol P₁ shown in FIG. 9 represents a point on an optical path between the convex lens 12 and the first cylindrical lens 13. A symbol P₂ represents a point on an optical path between the second cylindrical lens 14 and the third cylindrical lens 15. In the present embodiment, the polarizer or the analyzer is disposed at the points P₁ or P₂, for example.

A symbol α shown in FIG. 9 represents an angle of an illumination optical system against the wafer 21, i.e., an incidence angle of the line beam. A symbol β represents an angle of an imaging optical system against the wafer 21, i.e., an output angle of the line beam. If those angles are equal to each other, the optical system in the pattern inspection apparatus becomes a bright field optical system. If those angles are different from each other, the optical system in the pattern inspection apparatus becomes a dark field optical system. The present embodiment can be applied to both optical systems.

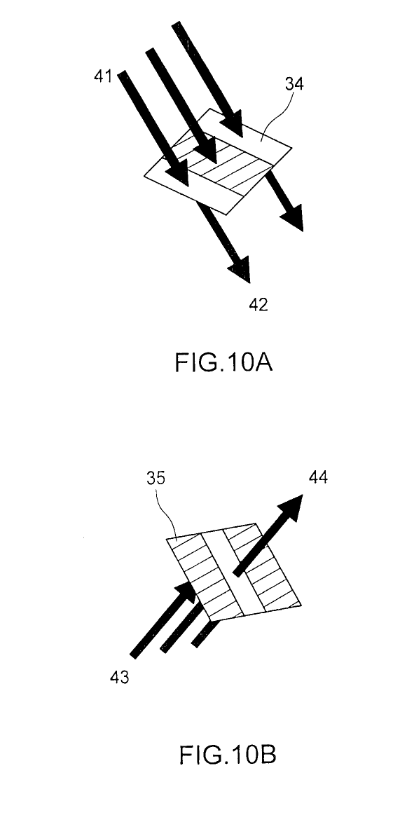

Even if the incidence angle a and the output angle β are equal to each other, the dark field optical system can be constructed by disposing spatial filters of FIGS. 10A and 10B on the optical paths of the illumination optical system and the imaging optical system, respectively.

FIGS. 10A and 10B are schematic diagrams showing configurations of the spatial filters in the third embodiment. FIG. 10A shows a spatial filter 34 on the optical path of the illumination optical system, and FIG. 10B shows a spatial filter 35 on the optical path of the imaging optical system. Reference numerals 41 and 43 denote incident light onto the spatial filters 34 and 35, respectively. Reference numerals 42 and 44 denote light transmitted through the spatial filters 34 and 35, respectively.

The spatial filter 34 is disposed at, for example, the point P₁ shown in FIG. 9, and the spatial filter 35 is disposed at, for example, the point P₂ shown in FIG. 9. Owing to those spatial filters 34 and 35, it is possible to select an angle of light components which form the illumination light onto the wafer 21, and an angle of light components which form the incident light onto the prism 32.

Furthermore, in the present embodiment, a spatial filter which emphasizes the defect or a spatial filter which reduces noise may be disposed on the optical path of the illumination optical system or the imaging optical system depending on the type of the defect, the structure of the underlying pattern or the like.

Furthermore, the pattern inspection apparatus of the present embodiment may include a component other than the above-described components. An example of such a component includes an optical element having a function of converting a magnification, such as a relay lens.

According to the third embodiment, it is possible to detect the defect with high precision even if the structure and the defect of the wafer 21 vary and to conduct the pattern inspection with a fast throughput, similarly to the first and second embodiments.

The configurations of the first to third embodiments may be partially combined. For example, in the first embodiment, only the lamp light source 11 among the lamp light source 11, the grating 16, and the CCD sensor 17 may be replaced by the supercontinuum light source 31.

While certain embodiments have been described, these embodiments have been presented by way of example only, and are not intended to limit the scope of the inventions. Indeed, the novel apparatuses and methods described herein may be embodied in a variety of other forms; furthermore, various omissions, substitutions and changes in the form of the apparatuses and methods described herein may be made without departing from the spirit of the inventions. The accompanying claims and their equivalents are intended to cover such forms or modifications as would fall within the scope and spirit of the inventions.

1. A pattern inspection apparatus comprising:
a light source configured to generate light;
a condenser configured to shape the light into a line beam to illuminate a wafer with the line beam;
a spectrometer configured to disperse the line beam reflected from the wafer;
a two-dimensional detector configured to detect the line beam dispersed by the spectrometer, and output a signal including spectrum information of the line beam;
a comparison unit configured to compare the spectrum information obtained from corresponding places of a repetitive pattern on the wafer with each other; and
a determination unit configured to determine whether the wafer includes a defect, based on a comparison result of the spectrum information.

2. The apparatus of claim 1, wherein the light source is a white light source configured to generate white light.

3. The apparatus of claim 2, wherein the white light source is a lump light source, a supercontinuum light source, or a superluminescent diode light source.

4. The apparatus of claim 1, wherein the comparison unit calculates a difference of intensities of the line beams obtained from the corresponding places of the repetitive pattern on the wafer.

5. The apparatus of claim 4, wherein the determination unit determines that the wafer includes the defect, if the difference of the intensities of the line beams is greater than a threshold at a wavelength.

6. The apparatus of claim 1, wherein the comparison unit compares the spectrum information between different chips provided on the wafer.

7. The apparatus of claim 1, wherein the comparison unit compares the spectrum information obtained from the repetitive pattern in the same chip on the wafer.

8. The apparatus of claim 1, wherein the condenser is a cylindrical lens.

9. The apparatus of claim 1, wherein the spectrometer is a grating or a prism.

10. The apparatus of claim 1, further comprising an imager configured to form an image on the spectrometer with the line beam reflected from the wafer.

11. The apparatus of claim 1, further comprising a polarizer or an analyzer disposed between the light source and a setting position of the wafer, or between the setting position of the wafer and the spectrometer.

12. The apparatus of claim 11, the two-dimensional detector detects an intensity ratio or a phase difference between p-polarized light and s-polarized light obtained from the line beam.

13. The apparatus of claim 1, further comprising a spatial filter disposed between the light source and a setting position of the wafer or between the setting position of the wafer and the spectrometer, and configured to select an angle of a light component of illumination light onto the wafer or incident light onto the two-dimensional detector.

14. A pattern inspection method comprising:
generating light;
shaping the light into a line beam to illuminate a wafer with the line beam;
dispersing the line beam reflected from the wafer;
detecting the dispersed line beam by a two-dimensional detector, and outputting a signal including spectrum information of the line beam from the two-dimensional detector;
comparing the spectrum information obtained from corresponding places of a repetitive pattern on the wafer with each other; and
determining whether the wafer includes a defect, based on a comparison result of the spectrum information.

15. The method of claim 14, wherein the light is white light.

16. The method of claim 15, wherein the white light is lump light, supercontinuum light, or superluminescent diode light.

17. The method of claim 14, wherein the comparison comprises calculating a difference of intensities of the line beams obtained from the corresponding places of the repetitive pattern on the wafer.

18. The method of claim 17, wherein the determination comprises determining that the wafer includes the defect, if the difference of the intensities of the line beams is greater than a threshold at a wavelength.

19. The method of claim 14, wherein the comparison comprises comparing the spectrum information between different chips provided on the wafer.

20. The method of claim 14, wherein the comparison comprises comparing the spectrum information obtained from the repetitive pattern in the same chip on the wafer.
